(19) United States
(12) Patent Application Publication
(10) Pub. No.: US 2012/0203664 A1
(43) Pub. Date: Aug. 9, 2012

(54) CONTACTLESS WIRELESS TRANSACTION PROCESSING SYSTEM

(75) Inventors: Arthur Torossian, Glendale, CA (US); David Maxwell, Los Angeles, CA (US)

(73) Assignee: TYCOON UNLIMITED, INC., Vernon, CA (US)

(21) Appl. No.: 13/024,276

(22) Filed: Feb. 9, 2011

(51) Int. Cl. G06Q 30/06

(52) U.S. Cl. 705/26.41; 705/27.1

(57) ABSTRACT

A wireless transaction processing system, comprising a member seller associated with a data that has a machine-readable representation, and a member buyer having at least an Internet enabled device that can access the wireless transaction processing system. The wireless transaction processing system, through the Internet enabled device of the buyer identifies the buyer, including buyer physical location, receives the machine-readable representation of the data, and displays the received data by the Internet enabled device of the buyer. The wireless transaction processing system wirelessly transmits the buyer information (including buyer location information) and received data for verification and approval of transaction between buyer and seller without exchange of confidential information between a buyer and a seller, and without requiring seller specialty equipment.

### BACKGROUND OF THE INVENTION

1. Field of the Invention

This invention relates to wireless transaction processing system and, more particularly, to contactless transaction processing system using wireless mobile Internet devices.

2. Description of Related Art

Conventional wireless transaction or payment processing systems using wireless devices (such as handheld devices) have been known for a number of years. Most of the conventional wireless transaction or payment-processing systems using wireless devices are vendor-centric. That is, the entire system is designed and implemented with the view that the retailer is the “hub” or the focal point of the payment processing systems for transactions, and most (if not all) functionality to access the conventional wireless transaction or payment-processing systems is initiated by the merchant or the vendor.

Most vendor or merchant-centric systems are based on a retail business-model, which requires a retailer or merchant and a consumer with at least one card account (credit cards, debit cards, etc.). Conventional systems that are used in a retail environment suffer from obvious disadvantages in that they require the retailers or merchants to obtain additional, dedicated specialty wireless hardware or equipment to perform or execute wireless transaction or payment processing. Further, most of the retail or merchant dedicated hardware used for execution of wireless transactions require custom configuration and installation, which further add to the overall cost of providing wireless transaction processing service at the retail or merchant establishment.

Other obvious disadvantages of the conventional wireless transaction or payment processing systems using wireless devices is that they require wireless communication between the handheld device and the dedicated, specialty wireless hardware or equipment at the retail or merchant location. In most cases, wireless communication between any two entities introduces the possibility of interception (by a third party) of that which is wirelessly communicated between the two entities (e.g., the wireless handheld device and the dedicated wireless hardware at the retail or merchant location). With conventional systems, the communication between the handheld device and the merchant specialty equipment include confidential personal information, which further jeopardizes the overall identity and security of the users. Further, the mobile Internet devices must some how be configured to sync and function or work with the specialty equipment, which makes the mobile Internet device even more vulnerable to identify theft. Additionally, conventional systems developed (e.g., Near Field Communication—NFC) require specialized hardware to be installed either onto or within the wireless device (e.g., mobile phone) for full implementation of conventional wireless transaction or payment processing systems. Still other disadvantages of some conventional wireless transaction processing systems is that they aim to eliminate the use of encryption technology, which further enhances interception of wireless exchange of information between two entities by a third party.

Finally, the merchant or vendor-centric systems or retail business-models mentioned above do not accommodate entity-to-entity direct transactions where both entities are non-retailers or non-merchants (e.g., both entities may, for example, be individual persons).

Accordingly, in light of the current state of the art and the drawbacks to current wireless transaction processing systems mentioned above, a need exists for wireless transaction processing system that would be consumer-centric where the entities such as retailers or consumers (e.g., the mobile devices used) are not required to obtain additional, dedicated specialty wireless hardware or equipment to perform or execute wireless transaction or payment processing. Further, even if such transactions are accomplished wirelessly using additional wireless equipment, no personal or private confidential information is exchanged. Additionally, a need exists for a consumer-centric wireless transaction processing system where information exchanged is encrypted for security. Furthermore, a need exists for a consumer-centric wireless transaction processing system that would enable personal, direct transactions between individuals without requiring credit cards, involvement of retailers or merchants, or the involvement of fund transferring institutions. Finally, a need exists for integration of most types of transactions, including, but not limited to, most cashless transactions, payment, purchasing, and direct fund transfer between entities within a single system accessed by an Internet enabled mobile device.

### BRIEF SUMMARY OF THE INVENTION

An exemplary optional aspect of the present invention provides a wireless transaction processing system, comprising:
a seller that is a member of the wireless transaction processing system, and is associated with a data that has a machine-readable representation;
a buyer that is a member of the wireless transaction processing system, with the buyer having at least an Internet enabled device that can access the wireless transaction processing system;
the wireless transaction processing system, through the Internet enabled device of the buyer:
   identifies the buyer and generates a buyer ID;
   identifies a physical location of the buyer, and generates a buyer location information;
   receives the machine-readable representation of the data;
   displays the received data by the Internet enabled device of the buyer; and
wirelessly transmits the buyer ID, the buyer location information, and received data for verification and approval of transaction between buyer and seller.

Another exemplary optional aspect of the present invention provides a wireless transaction processing system, wherein:
the buyer and seller are provided with the authorization of the transaction.

Still another exemplary optional aspect of the present invention provides a wireless transaction processing system, wherein:
one of the buyer and seller is provided with authorization of the transaction.

Yet another exemplary optional aspect of the present invention provides a wireless transaction processing system as set forth in claim 1, wherein:
the received machine-readable representation of the data is one of a wireless signal and a data image.

A further exemplary optional aspect of the present invention provides a wireless transaction processing system as set forth in claim 1, wherein:
a third entity authorizes and approves transaction based on transmitted buyer ID, the buyer location information, and received data.

Another exemplary optional aspect of the present invention provides a purchasing system, comprising:
an Internet enabled handheld device that includes a wireless transaction processing system;
the handheld device captures an image of a machine-readable representation of a data associated with a seller and a desired goods and services of the seller, and generates a data-image;
wireless transaction processing system processes the data-image and displays seller information on the Internet enabled handheld device for confirmation and transmission to a third entity;
the third entity verifies the Internet enabled handheld device and data-image, and upon validation, provides authorization of transaction and actual payment for the desired goods and services.

Another exemplary optional aspect of the present invention provides a purchasing system, comprising:
a consumer that has an Internet enabled handheld device, and is a member of a wireless transaction processing system;
a vendor that is a member of the wireless transaction processing system, with the vendor, and goods and services of the vendor associated with one or more data with machine-readable representations;
the consumer selects the desired goods and services of the vendor for purchase, and accesses the wireless transaction processing system by the handheld device through an access protocol;
the wireless transaction processing system is provided with the consumer identification information, consumer-ID, which also includes consumer physical location;
the consumer selects desired account from which the consumer is to provide disbursement for the purchase of the desired goods and services of the vendor, and initiates disbursement protocols;
the disbursement protocols further provides the handheld device a selection of various interaction protocols, including purchase, a direct fund transfer, and bill-payment;
the consumer handheld device through a selection of the purchase module captures an image of the machine-readable representation of the data associated with the vendor and the desired goods and services of interest to consumer, and decrypts the data from the image, and displays the data;
the data is processed by the purchase protocol, which displays vendor identification (vendor-ID) to validate the vendor;
the consumer confirms vendor-ID and purchase amount, and transmits data to a third entity;
the third entity verifies the consumer-ID and data, and upon validation, provides authorization of transaction and actual payment for the desired goods and services.

Yet another exemplary optional aspect of the present invention provides a purchasing system, wherein:
the consumer and vendor are provided with the authorization of the transaction.

A further exemplary optional aspect of the present invention provides The purchasing system, wherein:
one of the consumer and vendor is provided with authorization of the transaction.

Still a further exemplary optional aspect of the present invention provides a purchasing system, wherein:
data-image further provides an Item identification (Item-ID) to validate the goods and services.

Another exemplary optional aspect of the present invention provides a wireless transaction processing system, comprising:
a first entity member that includes at least a first Internet enabled device, which requests funds from a second entity;
the second entity member includes at least a second Internet enabled device that is capable of:
   identifying the second entity member and generating a second-entity ID;
   identifying the first entity member and generating a first-entity ID;
   identifying a transaction associated with the requested funds and generating a transaction data; and
   wirelessly transmitting the second-entity ID, the first-entity ID, and transaction data to a third entity;
the third entity verifies the second-entity ID, the first-entity ID, and the transaction data, and upon validation, credits funds to the first entity member for immediate, instantaneous expenditure of credited funds by the first entity member using the first Internet enabled device for use in any purchasing environment, including use of credited funds with a physical existing vendor.

An exemplary optional aspect of the present invention provides a direct fund transfer system, comprising:
a first user that has an Internet enabled handheld device, and is a member of a wireless transaction processing system, which requests funds from a second user;
the second user has an Internet enabled handheld device, and is a member of a wireless transaction processing system;
the second user accesses the wireless transaction processing system by the handheld device through an access protocol;
the access protocol provides the wireless transaction processing system with the second user identification information, second-user-ID, which also includes a physical location of the second user;
through the access protocol, the second user selects desired account from which the second user is to provide a disbursement for the transfer of funds to the first user, and initiates disbursement protocols;
the disbursement protocols further provides the handheld device a selection of various interaction protocols, including purchase protocols, a direct fund transfer protocols, and bill-payment protocols;
the second user handheld device through a selection of the direct fund transfer protocols provides first user information and amount of transfer of funds;
the second user confirms and transmits first user information and the transfer amount to a third entity;
the third entity verifies the first user information and transfer amount, and upon validation, provides authorization of transaction and actual transfer of funds.

Still another exemplary optional aspect of the present invention provides a purchasing system, wherein:
the first and second users are provided with the authorization of the transaction.

Yet another exemplary optional aspect of the present invention provides The purchasing system, wherein:
one of the first and second users is provided with authorization of the transaction.

An exemplary optional aspect of the present invention provides a method for wireless transaction processing system for purchasing, comprising:
accessing a wireless transaction processing system mobile application;
transmitting identification information of a mobile Internet device and user to a wireless transaction processing system platform for verification;
using the wireless transaction processing system mobile application:
initiating disbursement protocols;
selecting purchase protocol;
receiving data associated with a seller and goods and services of the seller;
displaying information related to the data using the wireless transaction processing system mobile application;
confirming the displayed information;
transmitting data and user information to wireless transaction processing system platform for seller verification;
if seller and user location is equivalent, commencing validation and authorization of transaction; otherwise, terminating wireless transaction processing system.

Still another exemplary optional aspect of the present invention provides a method for wireless transaction processing system for direct transfer of funds, comprising:
accessing a wireless transaction processing system mobile application;
transmitting identification information of a mobile Internet device and payer to a wireless transaction processing system platform for verification;
using the wireless transaction processing system mobile application:
initiating disbursement protocols;
selecting direct transfer protocol;
entering payee information;
confirming the payee information;
transmitting payee and payer information to wireless transaction processing system platform for payer and payee verification;
crediting payee wireless transaction processing system account for immediate use in any purchasing environment, including use of credited funds with a physical existing seller;
debiting payer wireless transaction processing system account; and
displaying results in payer and payee mobile Internet device.

A further exemplary optional aspect of the present invention provides a computer program product for wireless transaction processing system for purchasing, the computer program product comprising a computer-readable medium having computer program instructions stored therein for causing a computer to perform operations of:
accessing a wireless transaction processing system mobile application;
transmitting identification information of a mobile Internet device and user to a wireless transaction processing system platform for verification;
using the wireless transaction processing system mobile application:
initiating disbursement protocols;
selecting purchase protocol;
receiving data associated with a seller and goods and services of the seller;
displaying information related to the data using the wireless transaction processing system mobile application;
confirming the displayed information;
transmitting data and user information to wireless transaction processing system platform for seller verification;
if seller and user location is equivalent, commencing validation and authorization of transaction; otherwise, terminating wireless transaction processing system.

Still a further exemplary optional aspect of the present invention provides a computer program product for wireless transaction processing system for direct transfer of funds, the computer program product comprising a computer-readable medium having computer program instructions stored therein for causing a computer to perform operations of:
accessing a wireless transaction processing system mobile application;
transmitting identification information of a mobile Internet device and payer to a wireless transaction processing system platform for verification;
using the wireless transaction processing system mobile application:
initiating disbursement protocols;
selecting direct transfer protocol;
entering payee information;
confirming the payee information;
transmitting payee and payer information to wireless transaction processing system platform for payer and payee verification;
crediting payee wireless transaction processing system account for immediate use in any purchasing environment, including use of credited funds with a physical existing seller;
debiting payer wireless transaction processing system account; and
displaying results in payer and payee mobile Internet device.

Another exemplary optional aspect of the present invention provides an apparatus, comprising:
a display, input device, processing apparatus, network interface,
said processing apparatus programmed for accessing a wireless transaction processing system mobile application;
   transmitting identification information of a mobile Internet device and user to a wireless transaction processing system platform for verification;
   using the wireless transaction processing system mobile application:
   initiating disbursement protocols;
   selecting purchase protocol;
   receiving data associated with a seller and goods and services of the seller;
   displaying information related to the data using the wireless transaction processing system mobile application;
   confirming the displayed information;
   transmitting data and user information to wireless transaction processing system platform for seller verification;
   if seller and user location is equivalent, commencing validation and authorization of transaction; otherwise, terminating wireless transaction processing system.

Another exemplary optional aspect of the present invention provides a purchasing system, comprising:
an Internet enabled handheld device that includes a wireless transaction processing system;
the handheld device receives wireless transmission of a machine-readable representation of a data associated with a vendor and a desired goods and services of the vendor;
wireless transaction processing system processes the transmitted data and displays vendor information on the Internet enabled handheld device for confirmation and transmission to a third entity;
the third entity verifies the Internet enabled handheld device and transmitted data, and upon validation, provides authorization of transaction and actual payment for the desired goods and services.

Such stated advantages of the invention are only examples and should not be construed as limiting the present invention. These and other features, aspects, and advantages of the invention will be apparent to those skilled in the art from the following detailed description of preferred non-limiting exemplary embodiments, taken together with the drawings and the claims that follow.

### BRIEF DESCRIPTION OF THE DRAWINGS

It is to be understood that the drawings are to be used for the purposes of exemplary illustration only and not as a definition of the limits of the invention. Throughout the disclosure, the word “exemplary” is used exclusively to mean “serving as an example, instance, or illustration.” Any embodiment described as “exemplary” is not necessarily to be construed as preferred or advantageous over other embodiments.

Referring to the drawings in which like reference character(s) present corresponding part(s) throughout:

FIG. 1A is an exemplary system overview of the wireless transaction processing system in accordance with the present invention;

FIG. 1B is an exemplary illustration of an online registration scheme of a wireless transaction processing system in accordance with the present invention for seller and buyer memberships;

FIG. 1C is an exemplary illustration of a set of information accessed by a user after login to the personal wireless transaction processing system account;

FIG. 1D is an exemplary illustration of computer system(s) of a wireless transaction processing system platform in accordance with the present invention;

FIG. 1E is an exemplary illustration of a well-known, conventional mobile Internet device that may be used with the wireless transaction processing system in accordance with the present invention;

FIGS. 2A to 2L are exemplary flowchart illustrations of the wireless transaction processing system in accordance with the present invention; and

FIGS. 3A to 3D are exemplary flowcharts illustrating a process of transfer of funds from one individual or entity to another individual or entity using the wireless transaction processing system in accordance with the present invention.

### DETAILED DESCRIPTION OF THE INVENTION

The detailed description set forth below in connection with the appended drawings is intended as a description of presently preferred embodiments of the invention and is not intended to represent the only forms in which the present invention may be constructed and or utilized.

For purposes of illustration, programs and other executable program components are illustrated herein as discrete blocks, although it is recognized that such programs and components may reside at various times in different storage components, and are executed by the data processor(s) of the computers. Further, each block within a flowchart may represent both method function(s), operation(s), or act(s) and one or more elements for performing the method function(s), operation(s), or act(s). Each block may comprise of one or more protocol(s) for execution of one or more function(s), operation(s), or act(s). In addition, depending upon the implementation, the corresponding one or more elements may be configured in hardware, software, firmware, or combinations thereof.

This disclosure defines a seller as one or more entity that promotes, exchanges, or sells goods and or services for money. Non-limiting examples of a seller may include, for example, a vendor, retailer, merchant, wholesaler, dealer, professional entities such as accountants, attorneys, etc. This disclosure defines a buyer as one or more entity that makes a purchase. Non-limiting examples of a buyer may include, for example, a purchaser, consumer, etc. It should further be noted that a purchasing environment may generally be defined as one where any expenditure of funds or money is exchanged for goods and services. Finally, a seller may have a physically existing real world “brick-and-mortar” location or presence, or, alternatively, a seller may solely have an online or virtual presence. It should further be noted that there are instances where a seller may have both an online and a physically existing presence. For example, a bookstore may have both an online presence, and also have a physically existing presence in a physically existing geographic location such as in a city.

The present invention provides a contactless transaction processing system using wireless mobile Internet devices that is consumer-centric. The consumer-centric contactless transaction processing system of the present invention using wireless mobile Internet devices obviates the mandatory requirement for the entities such as retailers to obtain additional, dedicated specialty wireless hardware or equipment to perform or execute wireless transaction or payment processing. Further, even if such transactions are done wirelessly using specialty equipment, no personal or private confidential information is exchanged when using the wireless transaction processing system of the present invention. Additionally, the contactless consumer-centric wireless transaction processing system of the present invention exchanges information using encryption and other well-known methodologies for security. Furthermore, the wireless transaction processing system of the present invention enables personal, direct transactions between individuals without requiring credit cards, involvement of retailers or merchants, or the involvement of fund transferring institutions. Finally, contactless transaction processing system using wireless mobile Internet devices of the present invention integrates most types of transactions, including, but not limited to, cashless transactions, payment, purchasing, and direct fund transfer between entities within a single system accessed by a mobile device.

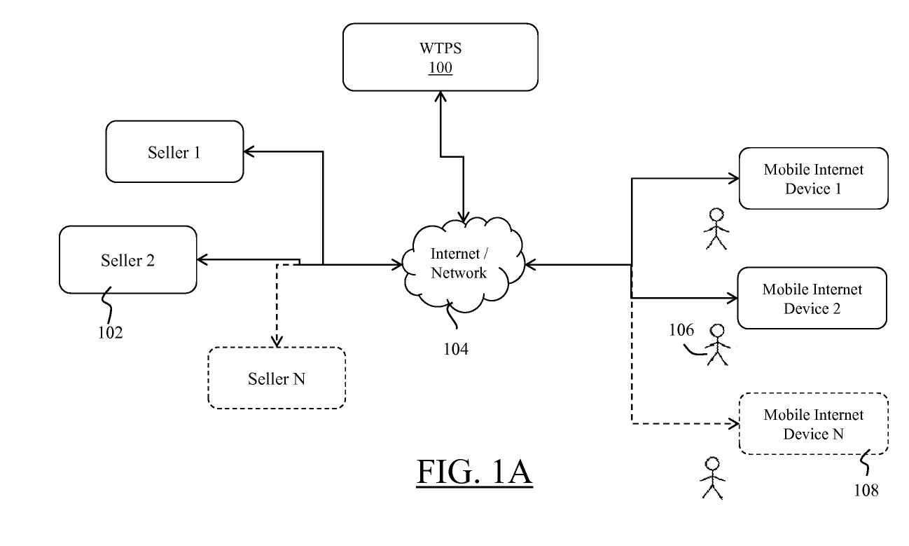

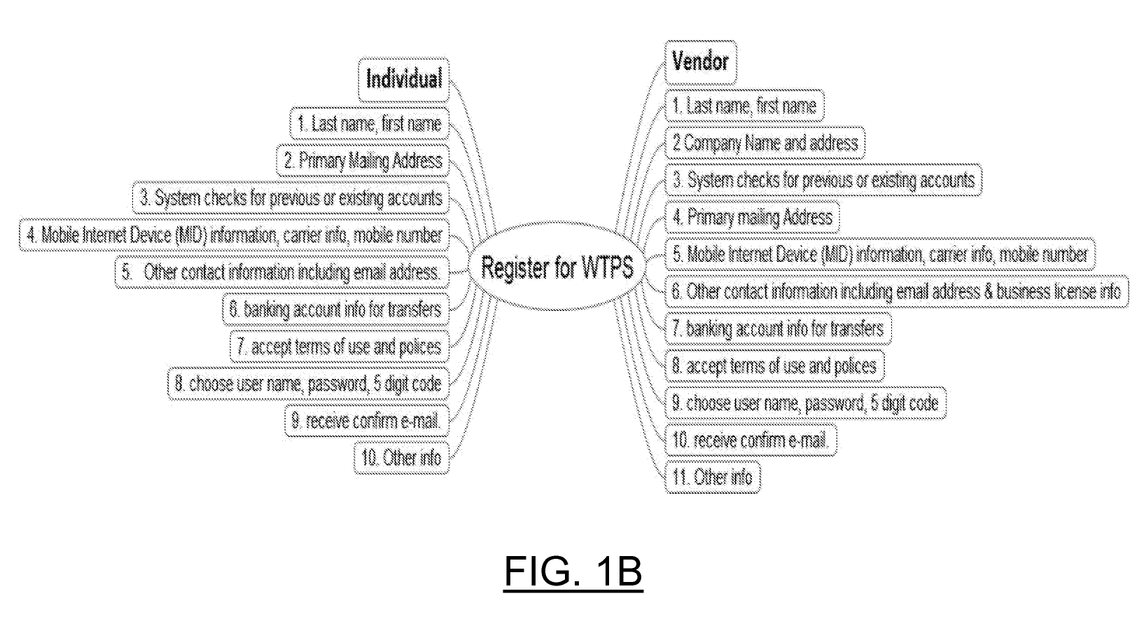

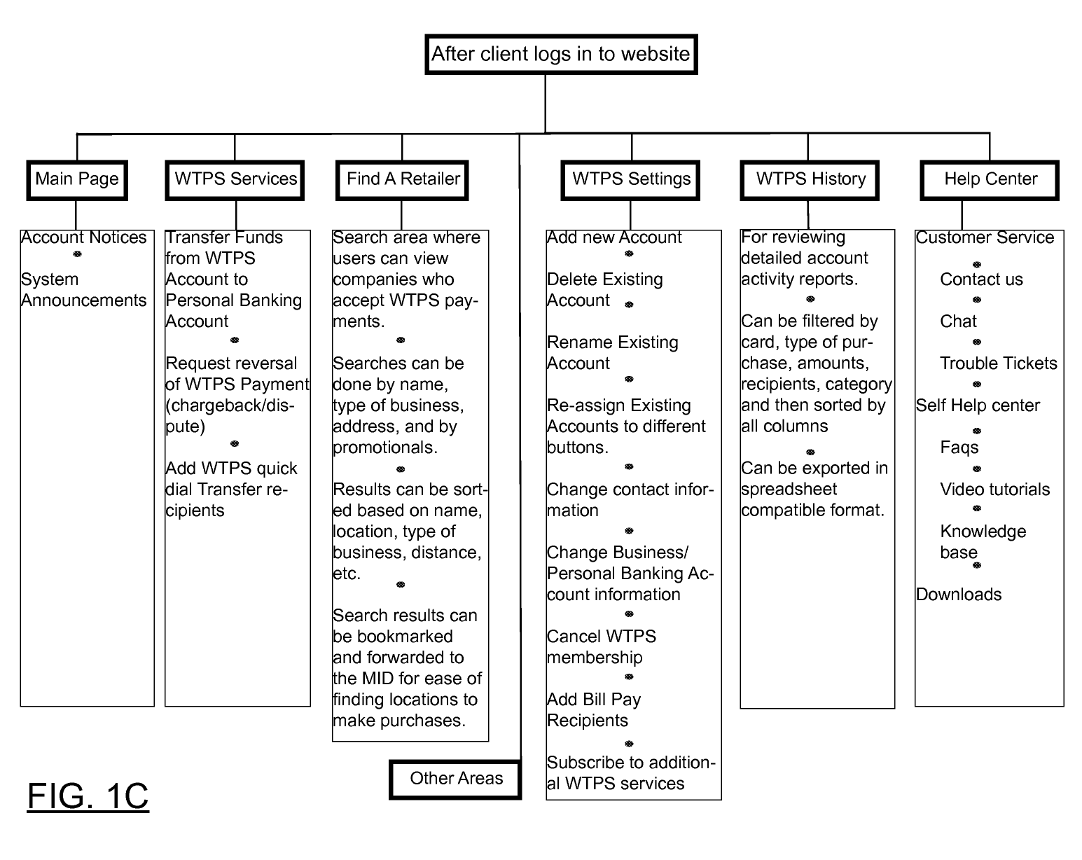

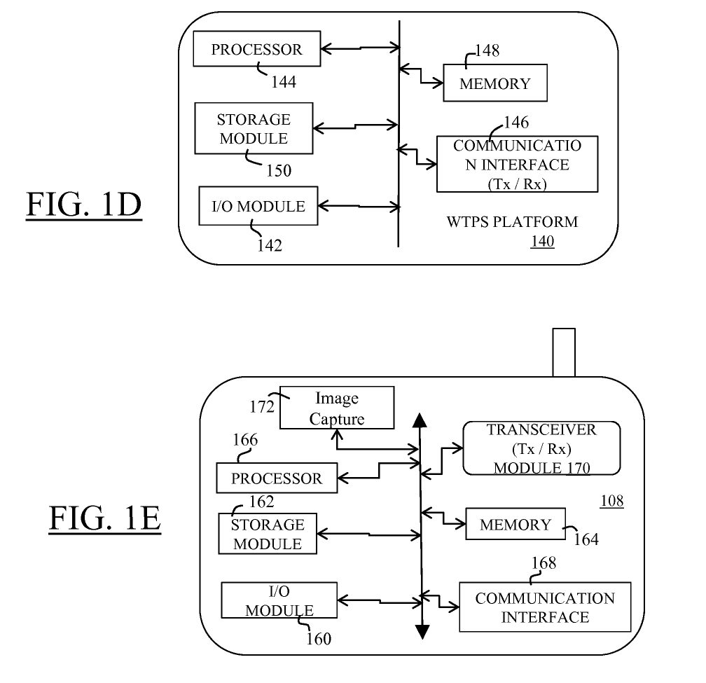

FIG. 1A is an exemplary system overview of the wireless transaction processing system in accordance with the present invention. As illustrated, the contactless wireless transaction processing systems (hereinafter referred to as “WTPS”) 100 of the present invention includes one or more seller 102 that is associated with the WTPS 100, and communicatively associated therewith via Internet or a network 104. In this exemplary instance, the seller 102 is a seller that is a registered member of the WTPS 100, and may (for example) be a neighborhood convenient store.

As further illustrated, the WTPS 100 of the present invention includes one or more buyer 106 that is associated with the WTPS 100, and communicatively associated therewith via Internet or a network 104 using a mobile Internet device 108. In this exemplary instance, the buyer 106 is a registered member of the WTPS 100, with the buyer having at least one Internet enabled device 108 that can access the WTPS 100 via the Internet or network 104.

As a non-limiting example, with the WTPS 100 of the present invention, a buyer 106 that is a member of the WTPS 100 may walk into a convenient store 102 that is also a member of the WTPS 100 without carrying any cash or credit cards, purchase the desired goods and services of the member seller 102, and complete a transaction for purchase of the goods and services using the mobile Internet enabled device 108. The member seller 102 is not required to have any specialty equipment, and no confidential information is exchanged between the member seller 102 and the member buyer 106.

As yet another non-limiting example, with the WTPS 100 of the present invention, a first individual member may directly transfer funds to a second individual member anywhere at anytime for immediate use by the second individual member using the mobile Internet device 108, and without accessing their respective bank accounts, or requirement of any specialty equipment.

FIG. 1B is an exemplary illustration of an online registration scheme of a wireless transaction processing system in accordance with the present invention for seller 102 and buyer 106 memberships. As with most conventional online registration schemes, seller 102 and buyer 106 may access the online registration site of the wireless transaction processing system website to create an account and register with the WTPS 100. The required information and processing for creation of an account and registration is similar to known processes that create conventional online bank use accounts with most commercial banks It should be noted that after a buyer becomes a registered member of the wireless transaction processing system, a mobile app (or a mobile application) of the WTPS 100 is automatically downloaded to the mobile Internet device 108 (such as a mobile phone) of the buyer 106, where the buyer 106 can associate and communicate with the WTPS 100. On the other hand, after a seller 102 becomes a registered member of the WTPS 100, the seller 102 can associate and communicate with the WTPS 100 at the physical location of the seller 102 by a variety of means, including a seller mobile device (associated with the system 100 during registration), specialty equipment (if desired), or simple mobile phone (associated with the WTPS 100 during registration).

At a minimum, the WTPS 100 registration system requires seller and buyer identification information, non-limiting, non-exhaustive list of examples of which are exemplarily illustrated in FIG. 1B, including device-ID for their respective mobile Internet devices, business information of the seller, and so on.

FIG. 1C is an exemplary illustration of a set of information accessed by a user after login to the personal wireless transaction processing system account. As with most conventional online banking account schemes, a user (seller 102, buyer 106, administer, or other authorized entities) may access their online account after login through any Internet enabled device. A WTPS 100 user account (e.g., buyer or seller) includes typical information about user balances, and other typical, well-known tools illustrated in FIG. 1C such as account settings, history, help center, other services, and so on, the creation and uses of which are very well-known and similar to most online banking websites. Non-limiting, non-exhaustive list of examples of tools and information available in a WTPS user account are exemplarily illustrated in FIG. 1C, including association of personal accounts (such as credit, debit, checking, saving, investments, or other accounts) with the WTPS, and assignment of the associated account with a graphic user interface (GUI) for use, such as a soft button.

FIG. 1D is an exemplary illustration of computer system(s) of a wireless transaction processing system platform in accordance with the present invention. The computer system(s) of the wireless transaction processing system platform 140 may comprise of one or more computers or servers in one or more locations. As illustrated in FIG. 1D, the platform 140 is comprised of an input and output (I/O) module 142 for receiving information and or data from various entities, including, but not limited to various admin users, mobile Internet devices, sellers, buyers, or others, including any inputting mechanism, such as a communication module, an external computer connected to the platform, a network and or Internet connection, or any computer readable medium such as a floppy disk, Compact Disk (CD), a Digital Versatile Disk/Digital Video Disk (DVD), and a removable hard drive. The I/O module 142 may also be configured for receiving user input from another input device such as keyboard, a mouse, or any other input device best suited for the current environment conditions. Note that the I/O module 142 may include multiple “ports” for receiving data and user input, and may also be configured to receive information from remote databases using wired or wireless connections. The I/O module 142 is connected with the processor 144 for providing output to various entities, possibly through a video display. Output may also be provided to other devices or other programs, e.g. to other software modules, for use therein, possibly serving as a wired or wireless gateway to external databases or other processing devices such as mobile Internet devices 108. Further included is communication interface 146, which may include a wireless or wired transceiver Tx/Rx for implementing desired communications protocols. The processor 144 is coupled with a memory 148 to permit software such as control information to be manipulated by commands to the processor 144, and storage module 150 for storage of data.

FIG. 1E is an exemplary illustration of a well-known, conventional mobile Internet device that may be used with the wireless transaction processing system in accordance with the present invention. As illustrated, the mobile Internet device 108 is any well-known conventional mobile Internet device, including netbooks, notebooks, laptops, mobile phones, or any other device that is Internet enabled. The mobile Internet device 108 includes the typical, conventional components such as an I/O module 160 (e.g., a keypad, a display, etc.), a storage module 162 for storing information, a memory 164 used by a processor 166 to execute programs, a communication interface 168 for implementing desired communication protocol, a transceiver module 170 for transmitting and receiving data, and an image capture device such as a camera 172.

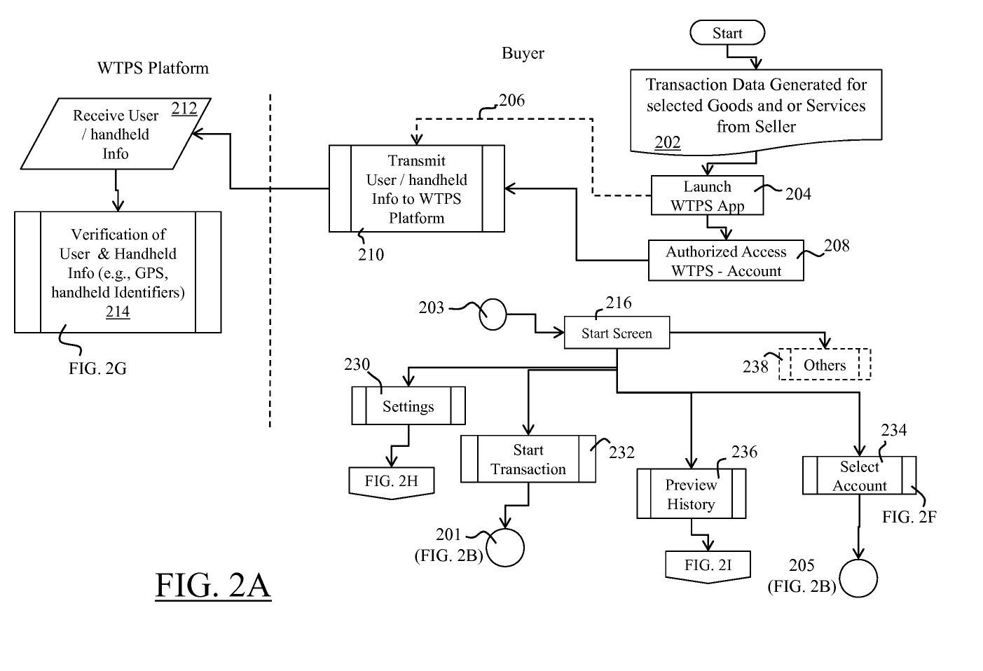

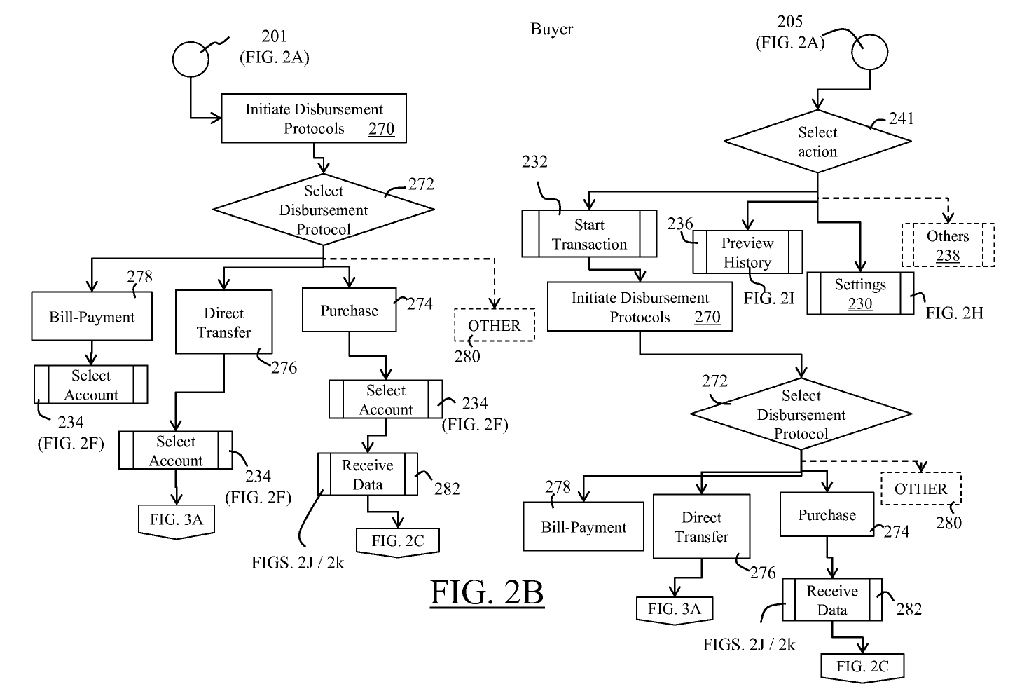

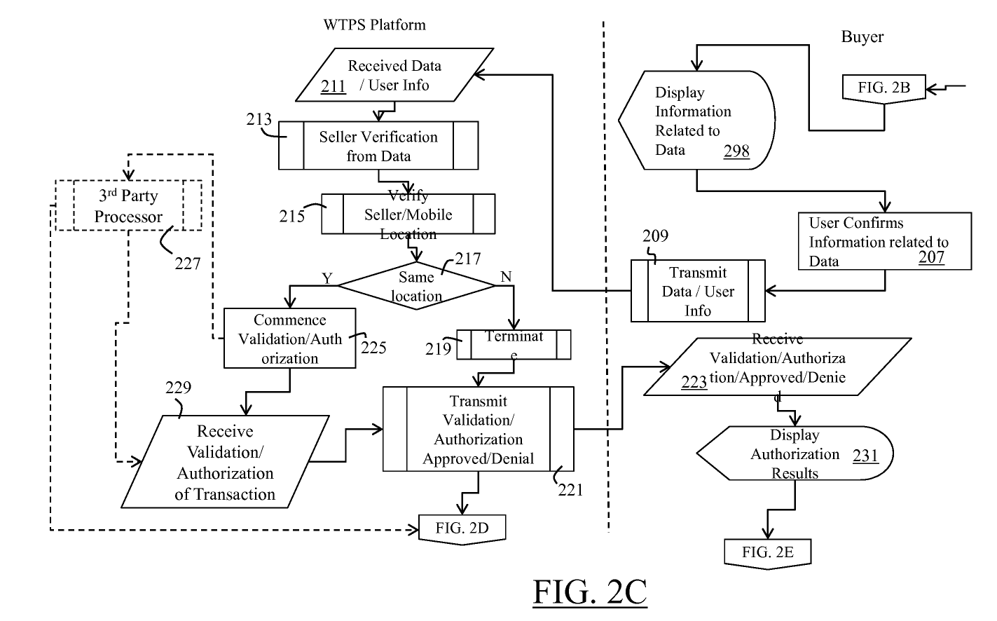

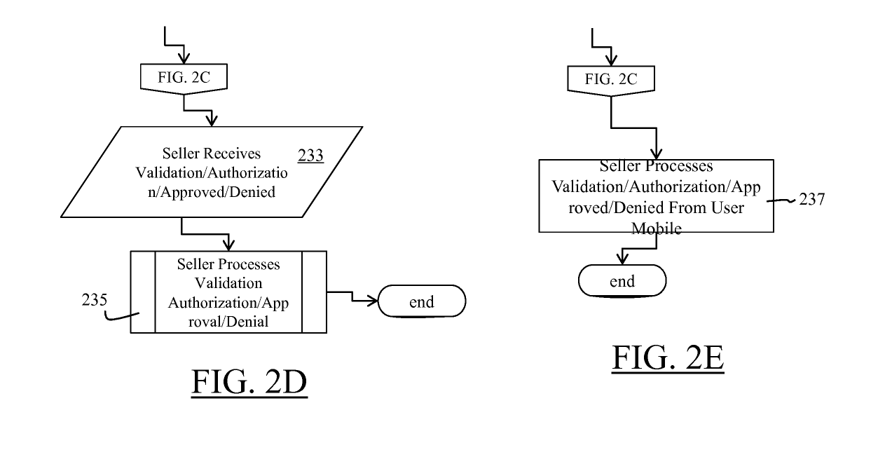

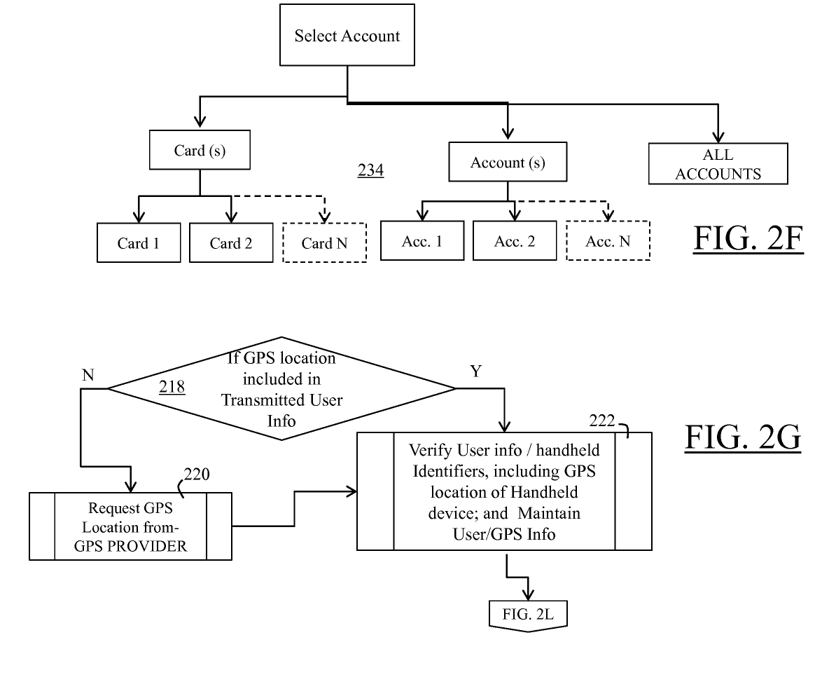

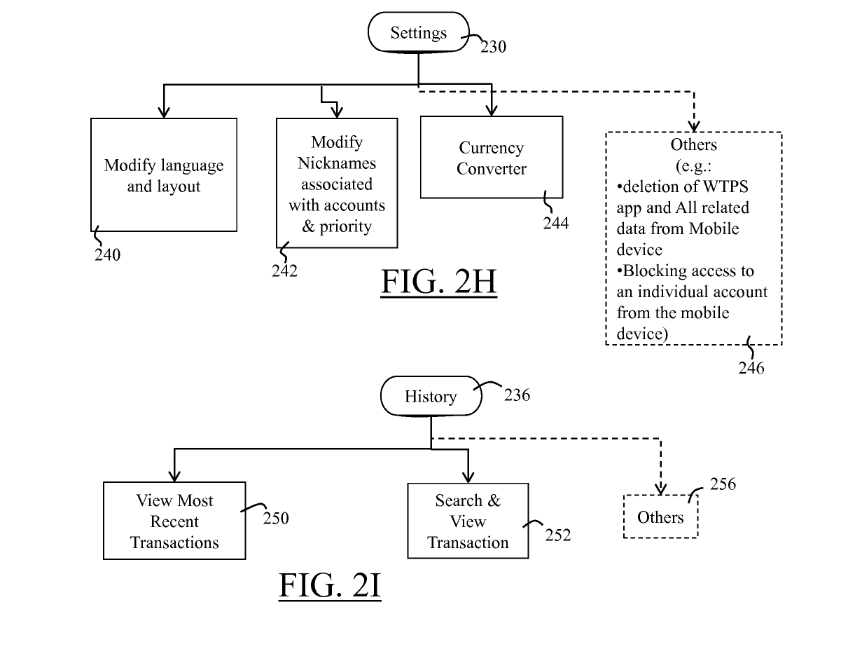

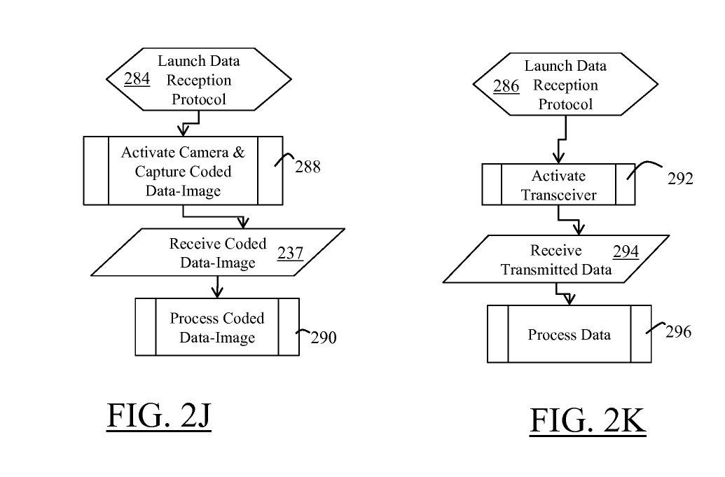

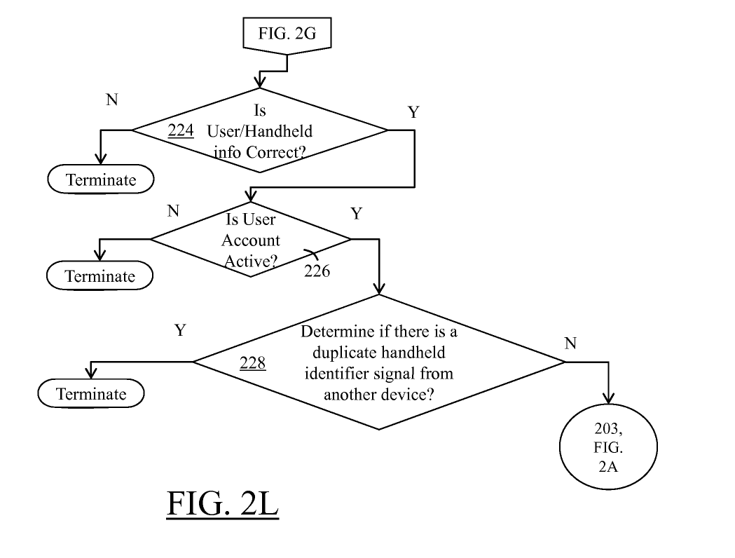

FIGS. 2A to 2L are exemplary flowchart illustrations of the contactless wireless transaction processing system in accordance with the present invention. As stated above, after a buyer becomes a registered member of the WTPS 100, a mobile app (or a mobile application) of the wireless transaction processing system is downloaded to the mobile Internet device 108 (such as a mobile phone) of the buyer 106, where the buyer 106 and the mobile Internet device 108 are associated and enabled to communicate with the WTPS 100.

The wireless transaction processing system application for the mobile device (hereinafter referred to as “WTPS app”) may be launched via the mobile Internet device 108 to enable a user (e.g., buyer 106) access to the WTPS user account. As illustrated in FIG. 2A, with the WTPS 100 of the present invention, a buyer 106 that is a member of the WTPS 100 may walk into a convenient store 102 that is also a member of the WTPS 100 without carrying any cash or credit cards, purchase the desired goods and services of the member seller 102, and complete a transaction for purchase of the goods and services using the mobile Internet enabled device 108. The member seller 102 is not required to have any specialty equipment, and no confidential information is exchanged between the member seller 102 and the member buyer 106. As illustrated, the buyer 106 may select the desired items from the exemplary convenient store 102 for purchase (e.g., a bag of groceries), with the seller 102 generating a transaction data for the buyer 106 (detailed below) for the selected goods and or services (functional act 202).

As further illustrated in FIG. 2A, in order to commence transaction using the WTPS 100 of the present invention, the buyer 106 must launch the WTPS app using the mobile Internet device 108 (operational functional act 204). The launching operation 204 of the WTPS app from the mobile Internet device 108 may immediately transmit location information 206 (via a typical GPS system) of the mobile Internet device 108 to the WTPS platform 140 through the operational functional act 210, and initiates an access protocol 208. Alternatively, the launch operation 204 of the WTPS app may simply initiate the access protocol 208 only, without an immediate transmission of location information 206 prior to authorized access. After the launch operation 204 of the WTPS app, the access protocol 208 using a graphic user interface (GUI) enables the authorized user to enter appropriate authorization code such as a password to allow access to the WTPS user account. The access protocol 208, through the operational functional act 210 provides the WTPS platform 140 with the consumer or buyer 106 identification information (buyer-ID) and buyer physical location via a typical GPS system. The WTPS platform 140 received that information via the operational functional act 212, and upon verification via the operational functional act 214 approves access to the WTPS app to launch a main screen or main page at the operational functional act 216 on the I/O module 160 of the mobile Internet device 108.

As illustrated in FIGS. 2A, 2G, and 2L, the verification operational functional act 214 to verify user 106 and the mobile Internet device 108 (e.g., a handheld device information) by the WTPS 100 includes the operational functional act 218, which, as illustrated in FIG. 2G, includes determining if the GPS location of the mobile Internet device 108 has been included in the transmitted information via the operational functional act 210. If the WTPS 100 determines that the GPS location is not included in the transmission operational functional act 210, the WTPS 100 requests GPS location from a GPS provider via the operational functional act 220. Otherwise, if the WTPS 100 determines that the GPS location is included, the system 100 verifies user and handheld (e.g., device 108) information, including location of the device 108 via the operational functional act 222.

As detailed in the exemplary flowchart of FIG. 2L, the verification process of the operational functional act 214 includes the operational functional act 224, which determines if the device 108 information (device signal-ID) is correct, and if so, if the WTPS user account is active (at the operational functional act 226), for example, has the account be canceled, mobile Internet device reported as stolen or lost, and so on. The determinations in the operational functional acts 224 and 226 may be accomplished by numerous methods, a non-limiting example of which may including the use of relational data base systems that easily compare the stored registration information of users (e.g., sellers and buyers) and their device information with incoming information via the operational functional act 210 (FIG. 2A).

As further illustrate in FIG. 2L, the WTPS 100 also determines if there is a duplicate device identifier signal from another device at the operational functional act 228. A duplicate device identifier signal may be generated, for example, by cloning a mobile Internet device. For example, a first user with original mobile Internet device in location “A” may request access to WTPS 100 at a first time interval, while a second user with a duplicate identifier signal (e.g., using a clone mobile Internet device) may request access to the WTPS 100 in location “B” simultaneously or at a subsequent second time period. This creates conflict in location (known as “location hopping”) of the mobile Internet device because a physical object cannot exist in two places at substantially short time frame. That is, the WTPS 100 “sees” the same phone (due to identical device signal identifiers) in two different geographic locations “A” and “B” within a short time frame. In such an instance, the operational functional act 228 based on the duplicate device signal identifier from two locations “A” and “B” will prevent both the first and the second users from accessing the WTPS 100 by terminating all further processing for both devices. This prevents a would be thief from stealing a device identifier signal (device signal-ID) of an original mobile Internet device and using that original device signal-ID to access WTPS 100 by a cloned version to access another persons WTPS user account to commence unauthorized transaction. It should be noted that the use of GPS or similar location identifier systems to access and use the WTPS 100 of the present invention is also used to verify that the consumer was at a particular location for purchase of goods and services from a seller.

Referring back to FIG. 2A, after authorized access by the buyer 106, the WTPS app within the mobile Internet device 108 displays the main page or start screen through the operational functional act 216 (via connector 203 in FIGS. 2L and 2A) where the user 106 may perform a variety of functions. Non-limiting examples of functions enabled may include modifying settings of the WTPS user account through the operational functional act 230, start of a transaction (operational function act 232), preview of account history (operational functional act 236), selecting an account associated with the WTPS user accounts (operational functional act 234) to perform a variety of functions associated with the selected account, or performance of other functions (operational functional act 238).

The present invention provides capabilities that enable a user to access the above-mentioned functionalities in a variety of manner. As illustrated in FIGS. 2A and 2B, the user may first select a specific account via the select account operational act 234 of FIG. 2A, and then select an action 241 of FIG. 2B (via the connector 205 between FIGS. 2A and 2B) to perform a function on that particularly selected account. For example, a user may first select an account via the operational functional act 234 of FIG. 2A (e.g., a business credit card account), and then select an action via the operational functional act 241, such as preview history of the selected account by the operational functional act 236 of FIG. 2B. As best illustrated in FIG. 2F, the select account module 234 enables a user to select any one or more specific accounts to perform a variety of tasks on the selected account. As another example, the user may first select an account via the operational functional act 234 of FIG. 2A (e.g., a personal debit card account), and then select an action 241 such as settings modifications by the operational functional act 230 of FIG. 2B for the selected account. As further illustrated, the user may also select an account via the operational functional act 234 of FIG. 2A (e.g., a bank checking account), and then select an action 241 such as starting a transaction by the operational functional act 232 of FIG. 2B using the selected bank checking account. Accordingly, from the main or start screen operational functional act 216 a user may simply select an account via the operational functional act 234 of FIG. 2A, and then select an action 241 in FIG. 2B that the user desires to perform in relation to the selected account.

Alternatively, the user may first select any of the above mentioned specific actions or functions, for example, from the main page or start screen 216, the user may select start of a transaction (operational function act 232 of FIG. 2A), preview of account history (operational functional act 236 of FIG. 2A), or performance of other functions (operational functional act 238 of FIG. 2A), and then optionally select an account via the operational functional act 234 of FIG. 2B to perform the selected function on that selected account.

As indicated above, the settings operational functional act 230 may be accessed via the main screen 216 (FIG. 2A) or, alternatively, after the selection of an account via the operational functional act 234 of FIG. 2A, with the user directed to the settings operational functional act 230 of FIG. 2B (via connector 205 and select action operational functional act 241). Using the settings operational functional act 230 (FIG. 2A or FIG. 2B) to modify WTPS user account settings (via the settings module 230, best illustrated in FIG. 2H) a user may set or modify WTPS user accounting settings in a variety of ways through the WTPS app, including (as best illustrated in FIG. 2H) modifying display language and overall layout for the mobile application via the operational functional act 240, associating or reassigning nicknames to various registered accounts such as a bank, credit or debit card account with the WTPS user account via the operational functional act 242. In addition, the operational functional act 242 enables users to prioritize and set as default certain accounts that the user uses the most. Other non-limiting examples of settings may include currency converters that may be set via the operational functional act 244, which convert currency in one denomination (e.g., when using the direct fund transfer of the present invention) to other denominations, if need be. Other settings feature via the operational functional act 246 may include deletion of WTPS app and all related data from Mobile device, or blocking access to an individual account from the mobile device.

As further indicated above, the preview history operational functional act 236 may be accessed via the main screen 216 (FIG. 2A) or, alternatively, after the selection of an account via the operational functional act 234 of FIG. 2A, with the user directed to the preview history operational functional act 236 of FIG. 2B (via connector 205 and select action operational functional act 241). Using the preview history operational functional act 236 to preview account history (preview history module is illustrated in FIG. 2I), a user may view most recent transactions via the operational functional act 250, search and view transactions based on a variety of different search criteria via the operational functional act 252, or perform other functions related to view of account history via the operational functional act 256. For example, operational functional act 256 may be a mode setting operation in which a user may set a mode that WTPS app preview account history in a limited time frame for all transactions (e.g., within the last 30 days only), which would expedite processing of the account history request on the mobile Internet device 108. In general, the account history module (FIG. 2I) may display seller information (e.g., seller name, location, etc.), date of transaction, the amount, or any other information relevant to account history. As with most other accounting GUIs, a user can drill down to view further account details by selecting a specific account, date, or other parameter to view further details of a particular transaction.

As further indicated above, the start transaction operational functional act 232 may be accessed via the main screen 216 (FIG. 2A) or, alternatively, after the selection of an account via the operational functional act 234 of FIG. 2A, with the user directed to the start transaction operational functional act 232 of FIG. 2B (via connector 205 and select action operational functional act 241). The start transaction operational functional act 232 enables a user (e.g., a buyer 106) to commence a desired transaction to purchase, transfer funds, pay bills, or other transactional functions. Through the start transaction 232 the consumer can provide disbursement of funds from a desired account (which was associated with the WTPS user account) for the purchase of desired goods and services of a seller 102. As best illustrated in FIG. 2B, the start transaction operational functional act 232 initiates a disbursement protocol 270, enabling the buyer 106 to select (via the operational functional act 272) various interaction protocols, including purchase 274, direct fund transfer 276, bill-payment 278, or other transactional protocols 280. The bill-payment 278 is very similar to known online bill payment systems, with the exception that funds to pay bills are paid through the various personal accounts (e.g., business credit card, bank checking account, etc.) of the user that are associated with the WTPS user account.

As illustrated in FIG. 2B, selection of purchase operational functional act 274 enables the buyer 106 to purchase a product and or service from a seller. Upon selection of the purchase operational functional act 274, the mobile Internet device 108 of the buyer 106 initiates a receive data operational functional act 282 (assuming an account has been selected by the select account 234). FIGS. 2J and 2K are non-limiting examples of implementing the receive data operational functional act 282. FIG. 2J is an exemplary flowchart comprised of operational functional acts that enable reception of data (associated with the seller and seller goods and or services) as an image, and FIG. 2K is an exemplary flowchart comprised of operational functional acts that enable reception of the data (associated with the seller and seller goods and or services) as a wireless signal.

Referring to FIG. 2J, upon activation of the purchase protocol operational functional act 274, the receive data operational functional act 282 is initiated, which launches the data-image reception protocol 284 to activate an image capturing mechanism 172 such as a camera on the mobile Internet device 108 using the operational functional act 288, and receive a coded-data image via the operational functional act 237. As detailed below, the coded data-image is an image of a machine-readable representation of the data associated with the seller and the desired goods and or services of interest to consumer (generated via the operational functional act 202). In general, each member seller 102 (and their goods and or services) is associated with a data that has a machine-readable representation.

Non-limiting, non-exhaustive listing of examples of data (e.g., shown as operational functional act 202 of FIG. 2A) that may be represented by a machine-readable representation or code are data packets (that may be wirelessly transmitted), or well-known barcodes or Quick Response (or QR) codes, an image of which may be captured by a camera. A QR code is a very well known matrix (or two dimensional) barcode, which is a machine-readable representation of data. Both QR code generator applications and QR code reader applications for wireless devices are also well-known and can easily be downloaded from a vast variety of web sources (mostly free of charge), similar to the manner of downloading a free Portable Document File (PDF) generator and reader. In fact, most mobile Internet devices 108 such as mobile phones may have a QR code reader application pre-installed.

Non-limiting, non-exhaustive listing of examples of information that may be included in the data (202 FIG. 2A) associated the member seller 102 may include seller information such as business name, physical address of the business, account information (in relation to the account created when the seller 102 registered to become a member of the wireless transaction processing system 100), and so on. Non-limiting, non-exhaustive listing of examples of information that may be included in the data associated the member seller 102 goods or services may include information about an item being sold, including, but not limited to, for example, item serial number, item price, and or any information that is printed on a typical receipt of a transaction when the seller 102 inputs the item information into a typical cash register and prints a conventional receipt.

Referring back to FIG. 2J, after receiving the data-image, it is processed by the process coded data image operational functional act 290, which displays the data to validate the seller on the I/O module 160 of the mobile Internet device 108, including all information available with the capture data-image such as purchase amount, date, or any other information found on a conventional receipt. Accordingly, the operational functional act 202 (FIG. 2A) is a transactional data print out with a QR code printed thereon, which is captured (or photographed) by the mobile Internet device camera 172, with no confidential or private information exchanged between seller and buyer. That is, the QR code or any other code generated by the seller has no confidential or private information.

As indicated above, FIG. 2K is an exemplary flowchart comprised of operational functional acts that enable reception of data as a wireless signal, rather than a coded data-image. As illustrated, upon activation of the purchase protocol operational functional act 274, the receive data operational functional act 282 is initiated, which launches the data reception protocol 286 to activate the transceiver module 170 of the mobile Internet device 108 using the operational functional act 292 to wirelessly receive coded-data by the operational functional act 294. The coded-data is a machine-readable data associated with the seller and the desired goods and or services of interest to consumer (generated via the operational functional act 202). In other words, the machine-readable data may be an image of a QR code, a barcode, or simply data packet that is transmitted as wireless data of information to the buyer 106 mobile Internet device 108. It should be noted that the seller may transmit the data by any means, including the seller mobile Internet device. Again, no confidential or private information is exchanged and the data transmitted has information that is found in a typical conventional receipt, with the addition of GPS and any other information desired.

Regardless of how the data is received (via the operational functional act 288 of FIG. 2J or the operational functional act 294 of FIG. 2K), the received data is processed by one of the operational functional acts 290 or 296, enabling the data to be displayed by the I/O module 170 of the mobile Internet device 108 in accordance with the operational functional act 298 (FIG. 2C). The data displayed may contain any information desired that is related to the seller 102 and the goods or services being purchased, non-limiting examples of which may include GPS location of the seller 102, or any other information found on a conventional receipt, item list, prices, taxes, etc., with no confidential or private information exchanged.

As further illustrated in FIG. 2C, the display of the data via the I/O module 160 by the mobile Internet device 108 in accordance with the operational functional act 298 enables the buyer 106 to confirm the data related to the transaction by the operational functional act 205, where the buyer 106 may be requested to confirm seller information such as a seller-ID, GPS location, purchase amount, or any other information that enables confirmation of the transaction by the buyer 106. Upon confirmation of data by the operational functional act 205, the confirmed data, and buyer information is transmitted via the operational functional act 207, and received by the WTPS platform 140 by the operational functional act 209. Non-limiting examples of buyer information may include transmitting of buyer GPS location again, and any other relevant information. It is imperative to note that at no time is there any exchange of private or confidential information between a seller 102 and a buyer 106. In other words, no confidential or private information is exchanged between seller 102 and buyer 106. For example, with conventional transactions, a buyer hands out a credit card to a seller, which includes the confidential information such as a credit card number, expiration data, and the name of the cardholder. With the present invention neither the seller 102 nor the buyer 108 exchange any confidential information, and all exchanged information may optionally be encrypted.

Referring back to FIG. 2C, the received data and buyer information by the WTPS platform 140 via the operational functional act 209 is then processed, which includes the operational functional act 211 of seller verification from data received. The operational functional act 211 simply verifies that the seller is a legitimate member of the WTPS system 100. This may include checking the instant received information against stored registration information of the seller. The operational functional act 213 verifies the seller member location in relation to the buyer member location. That is, as indicated in the operational functional act 215, WTPS system 100 determines if the buyer 106 is in the same physical location as the seller 102. If this condition is not met, the entire process is terminated (operational functional act 217), and a denial of service is transmitted to the buyer 106 via the operational functional act 219, where it is received by the operational functional act 221 of the WTPS app, and displayed by the I/O module 160 of the mobile Internet device 108 of the buyer 106.

As further indicated in the operational functional act 215, if WTPS system 100 determines that the buyer 106 is in the same physical location as the seller 102, then at the operational functional act 223 the WTPS system 100 commences validation/authorization protocol. It should be noted that the validation/authorization protocol may be accomplished by a third party processor 225, such as a bank or any other convention entity that processes credit, debit, or bank transactions. That is, information (such as buyer ID, buyer location information, and data is verified may be verified by WTPS 100, and another third party executes authorization of transaction (or credit approval) once verification by WTPS 100 has been completed. Additionally, as indicated by the flowchart of FIG. 2C, WTPS 100 may both verify users (buyers, sellers, and so on) and authorize transaction or credit approval.

Regardless of the entity that executes the validation/authorization protocol, the operational functional act 227 enables the WTPS platform 140 to receive the validation/authorization information, and transmit the same to both the buyer 106 and seller 102. The verification may include verifying the buyer-ID and data associated with the seller 102, and upon validation, providing authorization of transaction and actual payment for the desired goods and services from buyer 106 to seller 102. Non-limiting examples of verification may include verifying availability of funds in the selected account of the buyer for the selected transactions, limits or restrictions placed on the buyer account, or any other information that would cause termination or approval of the purchase, similar to the conventional manner that a credit card account of a buyer is verified (approved or denied) for a particular transaction. FIG. 2D is an exemplary flowchart that illustrated the receiving of verification/authorization by the seller and FIG. 2E is an exemplary flowchart that illustrated the receiving of verification/authorization by the buyer.

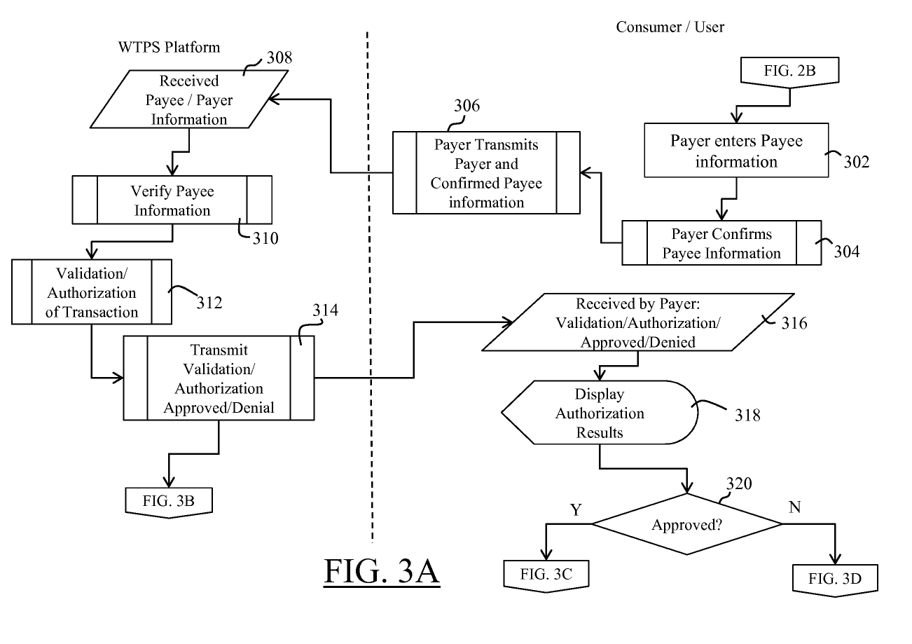

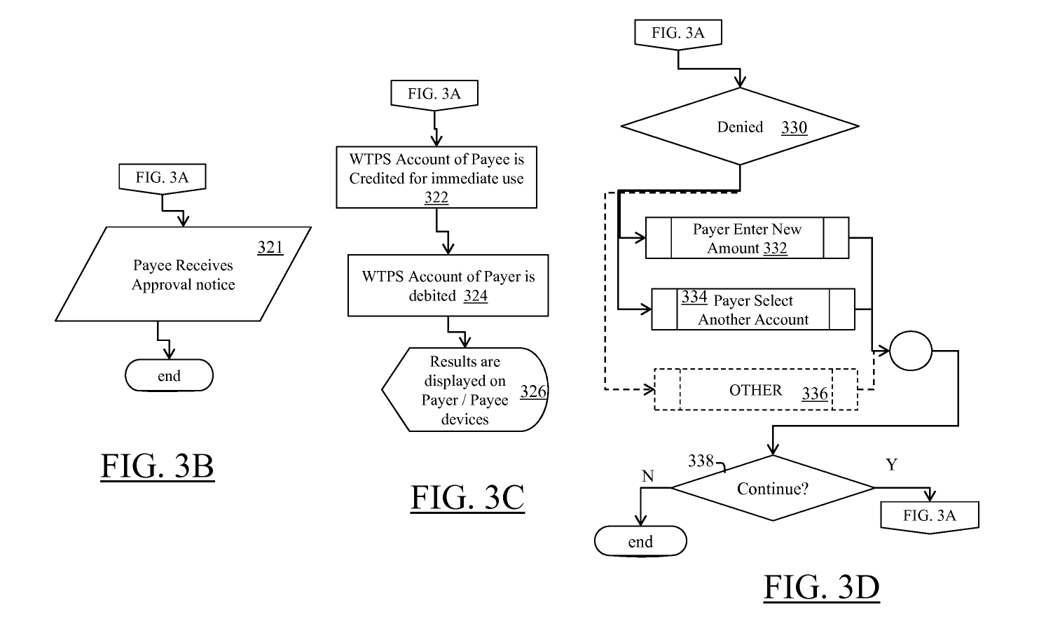

FIGS. 3A to 3D are exemplary flowcharts illustrating a process of transfer of funds from one individual or entity to another individual or entity using the wireless transaction processing system in accordance with the present invention. The selection of direct transfer operational functional act 276 (illustrated in FIGS. 2A and 2B) enables a first member (e.g., payee) of the WTPS 100 with a mobile Internet device 108 to request direct transfer of funds from a second member (e.g., payer) of the WTPS 100 that also has a mobile Internet device 108.

As illustrated, the second member (e.g., payer) accesses the wireless transaction processing system by the mobile Internet device 108 as described above in relation to FIGS. 2A to 2L, and is directed to the direct transfer operational functional act 276, and selects the desired account from which the second member (e.g., payer) is to provide a disbursement for the direct transfer of funds to the first user (e.g., payee). As best illustrated in FIG. 3A, the selection of the direct transfer operational functional act 276 initiates a GUI at the operational functional act 302 that would enable the second member (e.g., payer) to enter the destination of the funds to be transferred. That is, the second member enters the first member information, including the amount of transfer of funds in the operational functional act 302, and confirms the entered data or information at the operational functional act 304, where upon confirmation, the confirmed information is transmitted to the WTPS platform 140. That is, the WTPS app of the mobile Internet device 108 transmits both the payer information and confirmed payee information to the WTPS platform 140 via the operational functional act 306.

As further illustrated, the WTPS 140 received the transmitted information at the operational functional act 308, with WTPS 100 verifying first member (e.g., payee) information at the operational functional act 310. The WTPS 100 further executes validation and authorization protocols for the transaction at the operational functional act 312, and transmits results via the operational functional act 314 to second member (e.g., payer) and the first member (e.g., payee). As further illustrated, the second member (e.g., payer) receives the validation and authorization at the operational functional act 316, where WTPS app displays the results to the second member via the operational functional act 318.

As illustrated in FIG. 3B, the payee (first member) receives approval (if any) results at the operational functional act 321. If at the operational functional act 320 (FIG. 3A) the direct transfer of fund is approved (validated and authorized), the WTPS 100 credits the payee (the first member) selected account at the operational functional act 322 (FIG. 3C), and WTPS 100 debits the payer (second member) selected account at the operational functional act 324, and displays the respective results for respective payer and payee at the operational functional act 326. That is, the payee (first member) views that the selected account of the first member has been credited by the transfer amount, and the payer (second member) views that the selected account of the second member has been debited by the transfer amount.

Referring back to FIG. 3A, if the authorization results in denial (not approved) in the operational functional act 320, then as illustrated in FIG. 3C, several choices is presented to the payer (the second member). That is, if transfer is denied (operational functional act 330), payer may enter a new amount (at the operational functional act 332), select another account from which to transfer funds at the operational functional act 334, or perform other functions such as reschedule the same transfer to a later date at the operational functional act 336 (where funds may be available at some future date). The second member (e.g., payer) may then select to continue at the operational functional act 338 or terminate the entire process. Accordingly, as with purchasing a product, no private or confidential information is exchanged during the fund transfer.

What is claimed is:

1. A wireless transaction processing system, comprising:
a seller that is a member of the wireless transaction processing system, and is associated with a data that has a machine-readable representation;
a buyer that is a member of the wireless transaction processing system, with the buyer having at least an Internet enabled device that can access the wireless transaction processing system;
the wireless transaction processing system, through the Internet enabled device of the buyer:
identifies the buyer and generates a buyer ID;
identifies a physical location of the buyer, and generates a buyer location information;
receives the machine-readable representation of the data;
displays the received data by the Internet enabled device of the buyer; and
wirelessly transmits the buyer ID, the buyer location information, and received data for verification and approval of transaction between buyer and seller.

2. The wireless transaction processing system as set forth in claim 1, wherein:
the buyer and seller are provided with the authorization of the transaction.

3. The wireless transaction processing system as set forth in claim 1, wherein:
one of the buyer and seller is provided with authorization of the transaction.

4. The wireless transaction processing system as set forth in claim 1, wherein:
the received machine-readable representation of the data is one of a wireless signal and a data image.

5. The wireless transaction processing system as set forth in claim 1, wherein:
a third entity authorizes and approves transaction based on transmitted buyer ID, the buyer location information, and received data.

6. A purchasing system, comprising:
an Internet enabled handheld device that includes a wireless transaction processing system;
the handheld device captures an image of a machine-readable representation of a data associated with a seller and a desired goods and services of the seller, and generates a data-image;
wireless transaction processing system processes the data-image and displays seller information on the Internet enabled handheld device for confirmation and transmission to a third entity;
the third entity verifies the Internet enabled handheld device and data-image, and upon validation, provides authorization of transaction and actual payment for the desired goods and services.

7. A purchasing system, comprising:
a consumer that has an Internet enabled handheld device, and is a member of a wireless transaction processing system;
a vendor that is a member of the wireless transaction processing system, with the vendor, and goods and services of the vendor associated with one or more data with machine-readable representations;
the consumer selects the desired goods and services of the vendor for purchase, and accesses the wireless transaction processing system by the handheld device through an access protocol;
the wireless transaction processing system is provided with the consumer identification information, consumer-ID, which also includes consumer physical location;
the consumer selects desired account from which the consumer is to provide disbursement for the purchase of the desired goods and services of the vendor, and initiates disbursement protocols;
the disbursement protocols further provides the handheld device a selection of various interaction protocols, including purchase, a direct fund transfer, and bill-payment;
the consumer handheld device through a selection of the purchase module captures an image of the machine-readable representation of the data associated with the vendor and the desired goods and services of interest to consumer, and decrypts the data from the image, and displays the data;
the data is processed by the purchase protocol, which displays vendor identification (vendor-ID) to validate the vendor;
the consumer confirms vendor-ID and purchase amount, and transmits data to a third entity;
the third entity verifies the consumer-ID and data, and upon validation, provides authorization of transaction and actual payment for the desired goods and services.

8. The purchasing system as set forth in claim 5, wherein:
the consumer and vendor are provided with the authorization of the transaction.

9. The purchasing system as set forth in claim 5, wherein:
one of the consumer and vendor is provided with authorization of the transaction.

10. The purchasing system as set forth in claim 5, wherein:
data-image further provides an Item identification (Item-ID) to validate the goods and services.

11. A wireless transaction processing system, comprising:
a first entity member that includes at least a first Internet enabled device, which requests funds from a second entity;
the second entity member includes at least a second Internet enabled device that is capable of:
identifying the second entity member and generating a second-entity ID;
identifying the first entity member and generating a first-entity ID;
identifying a transaction associated with the requested funds and generating a transaction data; and
wirelessly transmitting the second-entity ID, the first-entity ID, and transaction data to a third entity;
the third entity verifies the second-entity ID, the first-entity ID, and the transaction data, and upon validation, credits funds to the first entity member for immediate, instantaneous expenditure of credited funds by the first entity member using the first Internet enabled device for use in any purchasing environment, including use of credited funds with a physical existing vendor.

12. A direct fund transfer system, comprising:
a first user that has an Internet enabled handheld device, and is a member of a wireless transaction processing system, which requests funds from a second user;
the second user has an Internet enabled handheld device, and is a member of a wireless transaction processing system;
the second user accesses the wireless transaction processing system by the handheld device through an access protocol;
the access protocol provides the wireless transaction processing system with the second user identification information, second-user-ID, which also includes a physical location of the second user;
through the access protocol, the second user selects desired account from which the second user is to provide a disbursement for the transfer of funds to the first user, and initiates disbursement protocols;
the disbursement protocols further provides the handheld device a selection of various interaction protocols, including purchase protocols, a direct fund transfer protocols, and bill-payment protocols;
the second user handheld device through a selection of the direct fund transfer protocols provides first user information and amount of transfer of funds;
the second user confirms and transmits first user information and the transfer amount to a third entity;
the third entity verifies the first user information and transfer amount, and upon validation, provides authorization of transaction and actual transfer of funds.

13. The purchasing system as set forth in claim 10, wherein:
the first and second users are provided with the authorization of the transaction.

14. The purchasing system as set forth in claim 10, wherein:
one of the first and second users is provided with authorization of the transaction.

15. A method for wireless transaction processing system for purchasing, comprising:
accessing a wireless transaction processing system mobile application;
transmitting identification information of a mobile Internet device and user to a wireless transaction processing system platform for verification;
using the wireless transaction processing system mobile application:
initiating disbursement protocols;
selecting purchase protocol;
receiving data associated with a seller and goods and services of the seller;
displaying information related to the data using the wireless transaction processing system mobile application;
confirming the displayed information;
transmitting data and user information to wireless transaction processing system platform for seller verification;
if seller and user location is equivalent, commencing validation and authorization of transaction; otherwise, terminating wireless transaction processing system.

16. A method for wireless transaction processing system for direct transfer of funds, comprising:
accessing a wireless transaction processing system mobile application;
transmitting identification information of a mobile Internet device and payer to a wireless transaction processing system platform for verification;
using the wireless transaction processing system mobile application:
initiating disbursement protocols;
selecting direct transfer protocol;
entering payee information;
confirming the payee information;
transmitting payee and payer information to wireless transaction processing system platform for payer and payee verification;
crediting payee wireless transaction processing system account for immediate use in any purchasing environment, including use of credited funds with a physical existing seller;
debiting payer wireless transaction processing system account; and
displaying results in payer and payee mobile Internet device.

17. A computer program product for wireless transaction processing system for purchasing, the computer program product comprising a computer-readable medium having computer program instructions stored therein for causing a computer to perform operations of:
accessing a wireless transaction processing system mobile application;
transmitting identification information of a mobile Internet device and user to a wireless transaction processing system platform for verification;
using the wireless transaction processing system mobile application:
initiating disbursement protocols;
selecting purchase protocol;
receiving data associated with a seller and goods and services of the seller;
displaying information related to the data using the wireless transaction processing system mobile application;
confirming the displayed information;
transmitting data and user information to wireless transaction processing system platform for seller verification;
if seller and user location is equivalent, commencing validation and authorization of transaction; otherwise, terminating wireless transaction processing system.

18. A computer program product for wireless transaction processing system for direct transfer of funds, the computer program product comprising a computer-readable medium having computer program instructions stored therein for causing a computer to perform operations of:
accessing a wireless transaction processing system mobile application;
transmitting identification information of a mobile Internet device and payer to a wireless transaction processing system platform for verification;
using the wireless transaction processing system mobile application:
initiating disbursement protocols;
selecting direct transfer protocol;
entering payee information;
confirming the payee information;
transmitting payee and payer information to wireless transaction processing system platform for payer and payee verification;
crediting payee wireless transaction processing system account for immediate use in any purchasing environment, including use of credited funds with a physical existing seller;
debiting payer wireless transaction processing system account; and
displaying results in payer and payee mobile Internet device.

19. An apparatus, comprising:
a display, input device, processing apparatus, network interface,
said processing apparatus programmed for accessing a wireless transaction processing system mobile application;
transmitting identification information of a mobile Internet device and user to a wireless transaction processing system platform for verification;
using the wireless transaction processing system mobile application:
initiating disbursement protocols;
selecting purchase protocol;
receiving data associated with a seller and goods and services of the seller;
displaying information related to the data using the wireless transaction processing system mobile application;
confirming the displayed information;
transmitting data and user information to wireless transaction processing system platform for seller verification;
if seller and user location is equivalent, commencing validation and authorization of transaction; otherwise, terminating wireless transaction processing system.

20. A purchasing system, comprising:
an Internet enabled handheld device that includes a wireless transaction processing system;
the handheld device receives wireless transmission of a machine-readable representation of a data associated with a vendor and a desired goods and services of the vendor;
wireless transaction processing system processes the transmitted data and displays vendor information on the Internet enabled handheld device for confirmation and transmission to a third entity;
the third entity verifies the Internet enabled handheld device and transmitted data, and upon validation, provides authorization of transaction and actual payment for the desired goods and services.
